(19) United States
(12) Patent Application Publication
(10) Pub. No.: US 2022/0188344 A1
(43) Pub. Date: Jun. 16, 2022

(54) DETERMINING AN ONTOLOGY FOR GRAPHS

(71) Applicant: International Business Machines Corporation, Armonk, NY (US)

(72) Inventors: Thuany Karoline Stuart, Nice (FR); Martin Oberhofer, Sindelfingen (DE); Lars Bremer, Boeblingen (DE); Hemanth Kumar Babu, Böblingen (DE)

(21) Appl. No.: 17/121,691

(22) Filed: Dec. 14, 2020

(51) Int. Cl. G06F 16/36; G06F 16/35; G06F 16/383; G06F 16/901; G06F 16/33

(52) U.S. Cl. CPC G06F 16/367; G06F 16/355; G06F 16/3331; G06F 16/9024; G06F 16/383

(57) ABSTRACT

The present disclosure relates to a method, computer program product and system. The method may comprise providing a first graph being an instance of a first ontology. Sample values of a plurality of concept attributes may be collected from the first graph. The sample values may be clustered into one or more clusters based on content and/or format of the sample values. A cluster of the clusters that contains sample values representing different concept attributes may be identified. An additional concept and associated set of relations representing the concept attribute values of the cluster may be determined and the first ontology may be updated using the additional concept and associated set of relations.

### BACKGROUND

This disclosure generally relates to the field of digital computer systems, and more specifically, to a method for determining an ontology.

A storage system may, for example, use graph structures for semantic queries with nodes, edges, and properties to represent and store data. The graph may relate the data items in the database to a collection of nodes and edges, the edges representing the relationships between the nodes. The relationships may allow data in the store to be linked together directly and, in many cases, be retrieved with a single operation.

### SUMMARY

Some embodiments may provide a method for determining an ontology, computer system, and computer program product as recited in the independent claims. Advantageous embodiments are described in the dependent claims. Embodiments of the present disclosure may be freely combined with each other if they are not mutually exclusive.

In one aspect, the disclosure relates to a computer implemented method comprising providing a first graph being an instance of a first ontology, the first ontology comprising concepts and relations, each concept of the concepts being associated with one or more concept attributes, collecting from the first graph sample values of a plurality of concept attributes of the concept attributes, clustering the sample values into one or more clusters based on content and/or format of the sample values, identifying a cluster of the clusters that contains sample values representing different concept attributes, wherein the number of the different concept attributes is higher than a predefined number, determining at least one additional concept and associated set of relations representing the concept attribute values of the cluster, and updating the first ontology using the additional concept and associated set of relations, thereby creating a second ontology.

In another aspect, the disclosure relates to a computer program product comprising a computer-readable storage medium having computer-readable program code embodied therewith, the computer-readable program code configured to implement the method according to preceding embodiments.

In another aspect, the disclosure relates to a computer system being configured for providing a first graph being an instance of a first ontology, the first ontology comprising concepts and relations, each concept of the concepts being associated with one or more concept attributes, collecting from the first graph sample values of a plurality of concept attributes of the concept attributes, clustering the sample values into one or more clusters based on content and/or format of the sample values, identifying a cluster of the clusters that contains sample values representing different concept attributes, wherein the number of the different concept attributes is higher than a predefined number, determining at least one additional concept and associated set of relations representing the concept attribute values of the cluster, and updating the first ontology using the additional concept and associated set of relations, thereby creating a second ontology.

Ontologies according to the present subject matter may evolve through regular modifications related to content of the corresponding graphs. This may improve the quality of the ontologies and associated graphs. For example, some embodiments may solve a design issue in which entities are modeled as attributes. Because it may be unfeasible to manually review the ontologies, this design issue may cause data to be repeated and cause inconsistencies in the graphs. For example, the update of the ontology as performed in accordance with the present subject matter may enable to obtain a graph with additional levels of details based on the same content of the graph. This may, for example, improve the deduplication of data of the graph. Thus, some embodiments may advantageously be used in a master data management (MDM) system. The MDM system may use graphs as persistency storage to identify duplicate records and needs to resolve them if applicable. Additionally, some embodiments may be used in a data governance catalog, where data modelers would like to understand improvements to the logical and physical data models describing the data assets managed by the data governance catalog.

Some embodiments may, for example, enable a system such as the MDM system to combine data from various data sources. In some of these embodiments, different data sources may have been designed differently and some of them might contain design choices that do not comply with referent practices and/or the ontology.

### BRIEF DESCRIPTION OF THE SEVERAL VIEWS OF THE DRAWINGS

In the following, embodiments of the disclosure are explained in greater detail, by way of example only, making reference to the drawings in which:

FIG. 1A is a diagram of a computer system consistent with some embodiments.

FIG. 1B is a diagram of a simplified structure of an ontology consistent with some embodiments.

FIG. 2 is a flowchart of a method for determining an ontology consistent with some embodiments.

FIG. 3A is a diagram illustrating a graph consistent with some embodiments.

FIG. 3B is a diagram illustrating a graph consistent with some embodiments.

FIG. 4A is a flowchart of a method for determining an ontology consistent with some embodiments.

FIG. 4B is a diagram of a simplified structure of an ontology consistent with some embodiments.

FIG. 4C is a diagram of a simplified structure of an ontology consistent with some embodiments.

FIG. 5A is a flowchart of a method for determining a set of relations of a new concept of an ontology consistent with some embodiments.

FIG. 5B is a table indicating relations of an ontology consistent with some embodiments.

FIG. 5C is a diagram of a simplified structure of an ontology consistent with some embodiments.

FIG. 5D is a diagram of a wizard consistent with some embodiments

FIG. 5E is a diagram of a simplified structure of an ontology consistent with some embodiments.

FIG. 6 represents a computerized system, suited for implementing one or more method steps as involved in the present subject matter.

### DETAILED DESCRIPTION

The descriptions of the various embodiments of the present disclosure will be presented for purposes of illustration, and are not intended to be exhaustive or limited to the embodiments disclosed. Many modifications and variations will be apparent to those of ordinary skill in the art without departing from the scope and spirit of the described embodiments. The terminology used herein was chosen to help explain the principles of the embodiments, the practical application, and the technical improvement over technologies found in the marketplace, or to enable others of ordinary skill in the art to understand the embodiments disclosed herein.

An ontology may encompass a representation, formal naming and definition of the categories, properties and relations between the concepts. The ontology may be provided by defining classes and class hierarchy. A class may be defined using general concepts such as concepts of a company database. A general concept may, for example, be a company. Subclasses may be defined based on the classes. For example, the company class may have subclasses that specialize the company. For example, a subclass may indicate employees associated with the company etc. Each of the classes may be associated with properties descriptive of the concept of the class. The concept may also be referred to as a class or entity type, and a concept attribute of the concept may also be referred to as attribute type. A graph may be built using a dataset descriptive of the domain of the ontology and the ontology, such that the graph is provided as an instance of the ontology. That is, the dataset may be encoded in the graph according to the ontology.

A graph may refer to a property graph where data values are stored as properties on nodes and edges. Property graphs may be managed and processed by a graph database management system or other database systems, which may provide a wrapper layer converting the property graph to, for example, relational tables for storage and convert relational tables back to property graphs when read or queried. The graph may, for example, be a directed graph. The graph may be a collection of nodes (also called as vertices) and edges. The edge of the graph may connect any two nodes of the graph. The edge may, for example, be represented by an ordered pair (v1, v2) of nodes and that can be traversed from node v1 toward node v2. A node of the graph may represent an entity or concept. The entity may refer to a user, object etc. The entity (and the corresponding node) may have certain one or more concept attributes or properties which may be assigned values. For example, a person may be an entity. The concept attributes of the person may, for example, comprise a marital status, age, gender etc. The attribute values that represent the node are values of the concept attributes of the entity represented by the node. The edge may be assigned one or more edge attribute values indicative of at least a relationship, of the ontology, between the two nodes connected to the edge. The attribute values that represent the edge may be values of the edge attributes. The relationship may, for example, comprise an inheritance (e.g. parent and child) relationship and/or associative relationship in accordance with a certain hierarchy. For example, the inheritance relationship between nodes v1 and v2 may be referred to as a “is-a relationship” between v1 and v2 e.g. “v2 is-a parent of v1”. The associative relationship between nodes v1 and v2 may be referred to as a “has-a relationship” between v1 and v2 e.g. “v2 has a has-a relationship with v1” means that v1 is part or is a composition of or associated with v2.

According to some embodiments, determining the set of relations associated with the additional concept comprises: identifying one or more existing relations of the first ontology, wherein each of the existing relations relates two concepts in accordance with a concept attribute of the cluster, reassigning the identified relations so that they are associated with the additional concept, defining one or more new relations based on concept attribute values of the cluster, wherein the set of relations comprises the reassigned relations and the new defined relations. The reassignment of the identified relations may, for example, automatically be performed.

For example, a relation such as locatedIn may link one concept representing a person and a concept representing a city. The city concept may have different concept attributes associated with it, such as: the population density, address where the person is located, etc. The relation locatedIn may thus be related to the concept attribute address of the city ontology (and not related to the population density attribute). So, if the concept attribute address is part of the identified cluster, the relation locatedIn may be reassigned because it is related to a concept attribute (address) that is now represented by a new concept.

According to some embodiments, defining the new relations may comprise providing an interface for enabling a user to assign the new relations to the additional concept, and receiving a user input indicative of the new relations. In one example, the interface may further be used to perform the reassignment of the exiting relations. For example, the interface may be a wizard that presents the user with a sequence of dialog boxes that lead the user through a series of steps in order to define the new relations.

According to some embodiments, the at least one additional concept may comprise one concept per concept attribute of the different concept attributes of the identified cluster.

In one example, one new concept may be defined to represent the concept attributes of the cluster, and in addition, a concept granularity may be defined e.g. a concept granularity may be a level of precision. The concept granularity may require that two or more concepts be derived from the one new concept. This may be advantageous as it may prevent having a same concept connected with a very high number of relations and may further improve the deduplication process.

According to some embodiments, the first graph may be built using a first dataset. The method may further comprise: building a second graph representing the second ontology using a second dataset or restructuring the first graph according to the additional concept and the set of relations in order to obtain the second graph, and using the second graph for accessing data instead of the first graph. Indeed, processing the graphs, e.g. for identifying duplicates, may technically be challenging in some applications because the graphs may have millions of edges connected to smaller number of nodes, such as a graph that stores data of millions of customer records, contracts, etc. as well as person records related to companies with hundreds of thousands of employees. Restructuring the graphs using some embodiments of this disclosure may solve this issue as the edges may be reassigned to a higher number of nodes. The restructuring of the first graph in order to obtain the second graph may, for example, be performed by executing an Extract-Transform-Load (ETL) job or task.

According to some embodiments, the first dataset and second dataset may comprise log data or results of data profiling jobs of same or different ETL systems. The log data may indicate, for example, instances of concepts and concept attributes of data processed by the data profiling. For example, the first dataset may comprise log data of data profiling of a first set of ETL systems and the second dataset may comprise log data of data profiling of a second set of ETL systems. The first and second sets of ETL systems may or may not be the same. In one example, the second set of ETL systems may comprise the first set of ETL systems in addition to other ETL systems. This may enable to provide the second dataset comprising the first dataset and more data.

According to some embodiments, restructuring the first graph may comprise: creating in the first graph one or more nodes representing instances of the additional concept, wherein the concept attributes values of the cluster become attribute values of the created nodes and/or attribute values associated with edges linked to the created nodes.

According to some embodiments, the method may further include the operation of automatic matching and identification of duplicates executed at least on the created nodes. This may improve and make simpler the de-duplication process because of the restructuration.

According to some embodiments, clustering the sample values may comprise: data profiling the collected sample values and performing the clustering based on the results of profiling. The data profiling may comprise one or more analyses that investigate the structure and content of the sample values, and make inferences about the sample values. An example analysis may comprise data classification analysis. The data classification analysis may infer a data class for each concept attribute. This may enable to compare domains of data to find data that contains similar values. The results of the data profiling may be statistics and inferences. The results of the profiling may then be used to cluster the sample values e.g. attributes classified as having similar values may belong to a single cluster.

According to some embodiments, the method may be applied during loading data from a plurality of data sources into a database storing the first graph. For example, the present method may be performed in response to receiving a load request to load data from one or more data sources. The data to be loaded may be inserted in the second graph making use of the new concept. This may enable a scalable solution for storing data because, when more data is received, the restructuration of the graph may be performed. Indeed, processing the graphs may technically be challenging because the graphs have usually millions of nodes and edges, such as a graph that stores data of millions of customer records, contracts, etc. as well as person records related to companies with hundreds of thousands of employees. Restructuring the graphs before inserting additional data may improve access to the graphs as it may provide a modular structure to the graphs.

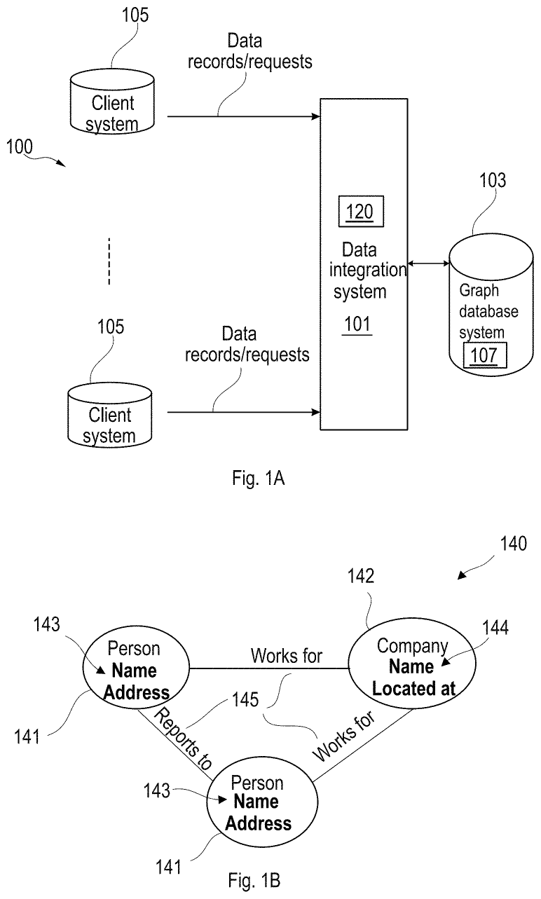

FIG. 1A depicts a computer system 100, consistent with some embodiments. The computer system 100 may, for example, be configured to perform master data management and/or data warehousing e.g. the computer system 100 may enable a de-duplication system. The computer system 100 may comprise a data integration system 101 and one or more client systems or data sources 105. The client system 105 may comprise a computer system (e.g. as described with reference to FIG. 6). The data integration system 101 may control access (read and write accesses etc.) to a graph database system 103.

The client systems 105 may communicate with the data integration system 101 via a network connection which comprises, for example, a wireless local area network (WLAN) connection, WAN (Wide Area Network) connection LAN (Local Area Network) connection, the internet, or a combination thereof.

The client system 105 may be configured to receive or generate a query request. For example, the client system 105 may generate or receive a query request for the graph database system 103. The query request may, for example, request the identification of duplicate nodes. The client system 105 may send or forward the query request to the data integration system 101. The data integration system 101 may be configured to fetch data using the graph database system 103 to compute the appropriate subsets of a graph 107 of the graph database system 103 to be sent back to the client system 105 in response to the query request. The graph 107 may represent an ontology as described, for example, with reference to FIG. 1B.

In another example, each client system 105 may be configured to send data records to the data integration system 101 in order to be stored by the graph database system 103. A data record or record may be a collection of related data items such as a name, date of birth and class of a particular entity. A record may represent an entity, wherein an entity may refer to a user, object, or concept about which information is stored in the record (the terms “data record” and “record” are interchangeably used). The graph database system 103 may use the graph 107 in order to store the records as entities with relationships, where each record may be assigned to a node or vertex of the graph 107 with properties being attribute values such as name, date of birth etc. The data integration system 101 may store the records received from client systems 105 using the graph database system 103, check for duplicate nodes in the graph 107 and/or detect data quality issues in the graph 107. For example, the client systems 105 may be configured to provide or create data records which may or may not have the same structure as the graph 107. For example, a client system 105 may be configured to provide records in XML or JSON format or other formats that enable to associate attributes and corresponding attribute values.

In one example, the data integration system 101 may import data records from a client system 105 using one or more Extract-Transform-Load (ETL) batch processes or via HyperText Transport Protocol (“HTTP”) communication or via other types of data exchange. The data integration system 101 and/or client systems 105 may be associated with, for example, Personal Computers (PC), servers, and/or mobile devices.

The data integration system 101 may be configured to process the graph 107 using one or more algorithms such as an algorithm 120 implementing at least part of the present method. For example, the data integration system 101 may process data records of the graph 107 using the algorithm 120 in order to update the ontology. Although shown as separate components, the graph database system 103 may be part of the data integration system 101 in another example.

FIG. 1B illustrates an example of an ontology 140. The ontology 140 includes concepts and relations or roles. The concepts and relations are illustrative examples of the terminological aspects of the ontology 140, consistent with some embodiments. The concepts and relations, in turn, may be expressed in various ways. FIG. 1B illustrates the concepts and relations in a graphical form.

The ontology 140 may contain concepts and relations. Each node in the ontology 140 may identify a concept. The ontology 140 may include, for example, a concept 141 representing Person and concept 142 representing company. The company concept 142 may be a superclass of the person concept 141.

The concepts may be associated to each other via one or more relations 145. Each of the relations 145 may be a property that connects two concepts. The ontology 140 may further comprise properties or concept attributes that describe the concepts and the relations. For example, a person concept may be associated with concept attributes 143 such as the name, age and address of the person. And a company concept may be associated with concept attributes 144 such as the name and location of the company.

The ontology 140 may be used to create the graph 107. For that, data descriptive of the domain of the ontology 140 may be used in combination with the ontology 140 in order to build the graph 107. The data descriptive of the ontology may, for example, comprise collected data of profiling tasks. With this collected data, as well as the ontology 140, specific instances of the elements of the ontology 140 may be created e.g. values of the concepts, relations and concept attributes may be determined resulting in the graph 107. The graph 107 may thus represent the ontology 140. The graph 107 comprises nodes representing instances of concepts and edges representing instances of relationships between the concepts.

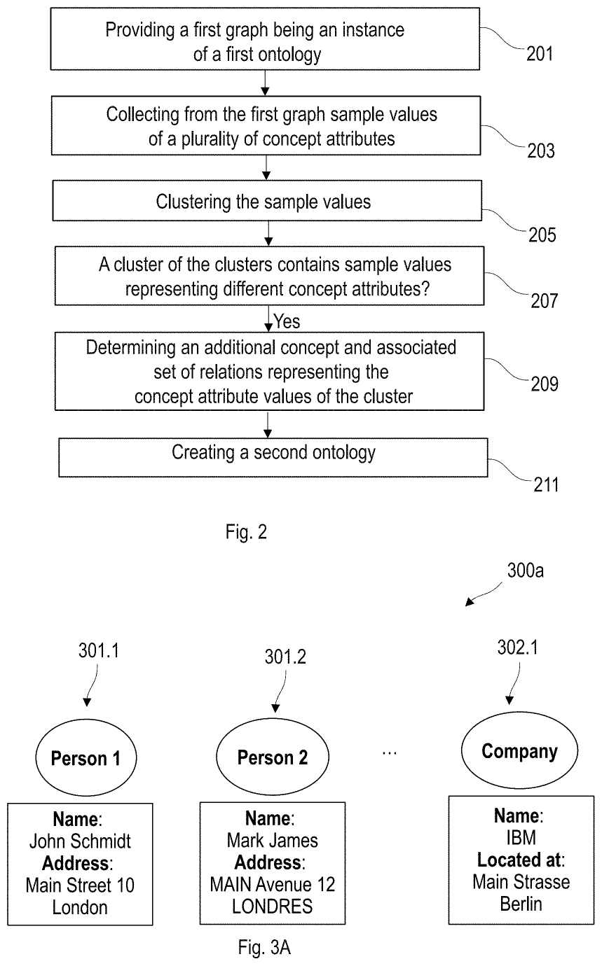

FIG. 2 is a flowchart of a method for updating or changing an existing first ontology e.g. 140 consistent with some embodiments. For purposes of explanation, the method described in FIG. 2 may be implemented using the system illustrated in FIGS. 1A-1B, but is not limited to this implementation. The method of FIG. 2 may, for example, be performed by the data integration system 101.

In operation 201, a first graph may be provided based on the first ontology 140. The first graph may be an existing graph, such as the graph 107, or a new graph created in operation 201. In both cases, the first graph may be created using the first ontology 140 and a first dataset. The first dataset may comprise data indicative of the first ontology e.g. the first dataset covers the domain of the first ontology. The first dataset may, for example, be a database about companies. The first dataset may, for example, comprise data collected from different ETL systems that process company databases. The first dataset may, for example, be obtained from profiling results of the multiple ETL systems. The first graph may comprise instances of the concept terms 141 and 142, of concept attributes 143 and 144 and of relations 145 of the first ontology 140. This may result in the first graph comprising multiple nodes. The first graph may, for example, be used to access data encoded in the first graph. In one example, the first graph may be accessed in order to perform cleaning operations such as deduplication.

The first graph 300a may comprise nodes such as nodes 301.1, 301.2 and 302.1 shown in FIG. 3A. For example, the nodes 301.1 and 301.2 represent the same concept, namely a person concept of the first ontology 140. The node 302.1 represents a company concept of the first ontology 140. Each of the nodes 301.1, 301.2 and 302.1 is associated with values of the concept attributes 143 and 144 of the person and company concepts respectively. For example, the two nodes 301.1 and 301.2 may be associated with values of the concept attributes 143 “Name” and “Address” associated with the person concept 141. The node 302.1 may be associated with values of the concept attributes 144 “Name” and “Located at” associated with the company concept 142. Although named similarly, the two concept attributes “Name” associated with the company concept 142 and person concept 141 may be considered different in the sense they belong to different concepts and may be referred to as Person.name and Company.name.

In operation 203, sample values of a plurality of concept attributes of the concept attributes may be collected from the first graph 300a. In one example, sample values of all the concepts terms of the first ontology may be collected in operation 203. This may enable to update the whole first ontology 140. In another example, sample values of a part of the concept terms of the first ontology 140 may be collected in operation 203. That part may, for example, be randomly selected or selected based on a selection criterion. The selection criterion may, for example, require the collection of sample values below a predefined maximum number of concept attributes. This may enable a focused or partial update of the first ontology 140. The collection of sample values of a concept attribute may be performed by identifying values of the concept attribute and selecting e.g. randomly a predefined number of values of the concept attribute from all values of the concept attribute. Following the example of FIG. 3, the sample values of the concept attribute Name may be John Schmidt and Mark James. The values of the four concept attributes 143 and 144, Person.name, Person.address, Company.name and Company.locatedAt may be provided per attribute type as follows:

Person.name: [sample_pn_1, . . . , sample_pn_n]

Person.address: [sample_pa_1, . . . , sample_pa_n]

Company.name: [sample_cn_1, . . . , sample_cn_n]

Company.locatedAt: [sample_cl_1, . . . , sample_cl_n]

The sample values may be clustered in operation 205 into one or more clusters based on content and/or format of the sample values. For example, a data profiling may be performed on the concept attributes to identify formatting, data types and more. The data profiling may comprise one or more analyses that investigate the structure and content of the sample values, and make inferences about the sample values. An example analysis may comprise a data classification analysis. The data classification analysis may infer a data class for each concept attribute. This may enable to compare domains of data to find data that contains similar values. The results of the data profiling may be statistics and inferences. The results of the profiling may then be used to cluster the sample values.

Following the example of FIG. 3A, the sample values of the concept attribute Address and the samples values of the concept attribute Located at may be clustered together in a same cluster as they have the same format and refer to addresses. For example, the following clusters may be formed:

Cluster 1 (people's names): [sample_pn_1, . . . , sample_pn_n]

Cluster 2 (companies' names): [sample_cn_1, . . . , sample_cn_n]

Cluster 3 (addresses): [sample_pa_1, . . . , sample_pa_n],

[sample_cl_1, . . . , sample_cl_n]

It may be determined (operation 207) whether one or more clusters of the clusters each contains sample values representing different concept attributes, wherein the number of the different concept attributes in each cluster of the one or more clusters is higher than a predefined number threshold e.g. the predefined number threshold is one. Following the example of FIG. 3A, the cluster (cluster 3) formed by the sample values of the concept attribute Address and the samples values of the concept attribute Located at may be identified in operation 205 because the cluster comprises values of two different concept attributes Address and Located at.

In case that the one or more clusters are identified, at least one additional concept may be determined (operation 209) for each cluster of the one or more clusters. The additional concept may represent concept attribute values of the respective cluster. Following the example of FIG. 3A, and as shown in FIG. 3B, a new concept named Location may be added to the first ontology 140. The name associated with the new concept may be defined by a user or automatically determined using the values of the concept attributes of the cluster e.g. one of said values may be used as the name of the new concept. This new concept may represent values of both concept attributes Located at and Address of the identified cluster 3. The additional concept may be associated with a set of one or more relations that link the additional concept to one or more other concepts of the first ontology.

The set of relations may be provided by, for example, assigning existing concept attributes of the cluster and/or reassigning existing relations to the additional concept. For example, the concept attributes Located at and Address may be reassigned as relations e.g. Located at and has address respectively. An existing relation between two concepts, which is a property proportional or related to one of the concepts' attributes of the cluster, may be reassigned as a relation of the additional concept. For example, an existing relation between a person and a company, indicting the billing address of the person as being the company's address may be reassigned so that it may relate that person with the additional concept Location. The set of relations may, for example, further comprise new defined relations e.g. based on the concept attributes of the cluster. In one example, the set of relations may be user defined e.g. the additional concept and the first ontology may be provided to a user for suggesting the set of relations, and a user input may be received indicting the set of relations.

Thus, the additional concept and the set of relations may be used to create a second ontology out of the first ontology in operation 211. The second ontology may comprise the first ontology, the additional concept, and the set of relations, wherein the first ontology may be adapted according to the reassignment of the relations and concept terms. The second ontology may be used to build a second graph.

As shown in FIG. 3B, a restructuration of the nodes of the first graph 300a may be performed so that new nodes representing the new concept are added to the first graph 300a. The first graph may, for example, be restructured to remove the address information from the person concept and add it to the location concept. This results in nodes of the second graph 300b. The second graph 300b may comprise new nodes 303.1, 303.2 and 303.3, which are instances of the new concept Location. The instance of a given node may be defined based on the value of the concept attribute of the cluster of the given node. This is indicated, for example, in FIG. 3B, where the new node 303.1 has a concept attribute value of the concept attribute Address obtained from the node 301.1.

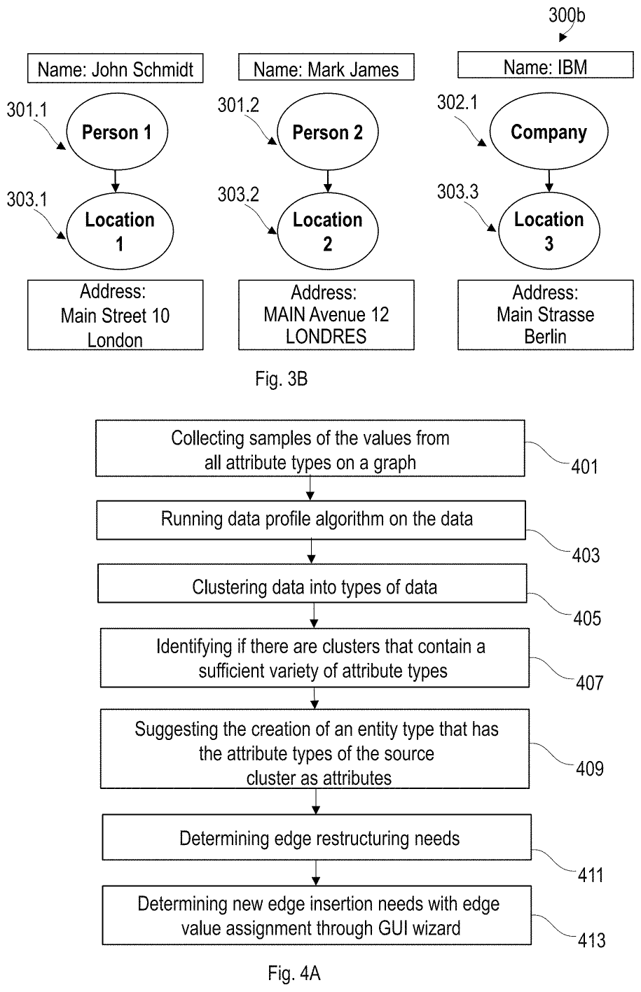

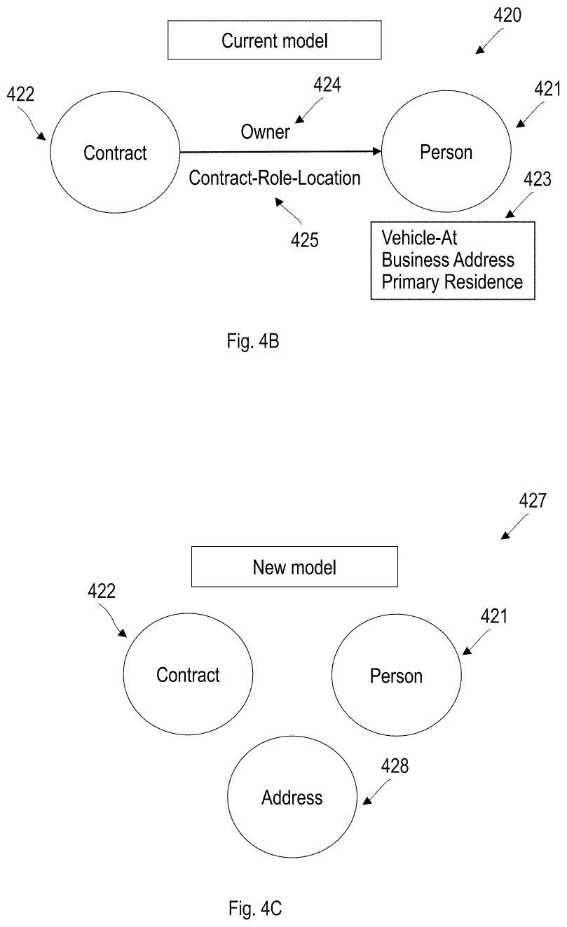

FIG. 4A is a flowchart of a method for structuring an existing graph, consistent with some embodiments. For the purpose of explanation, the method described in FIG. 4A may be implemented using the system illustrated in FIG. 1A, but is not limited to that implementation. The method of FIG. 4A may, for example, be performed by the data integration system 101.

The existing graph may, for example, represent the ontology 420 of FIG. 4B. The ontology 420 may, for example, comprise a concept 421 representing a person and another concept 422 representing a contract. For example, the person concept 421 may be associated with (or defined by) the concept attributes 423. The concept attributes 423 may, for example, comprise address related attributes such as Vehicle-At indicating where the vehicle of the contract is parked. The two concepts 421 and 422 may be related by relations such as Owner relation 424 indicating the owner of the contract and Contract-Role-Location relation 425 indicating the location of the contract role.

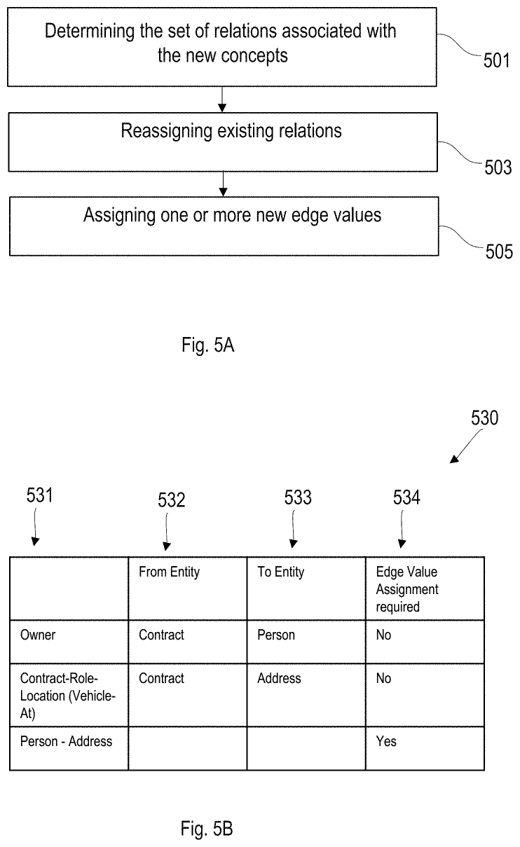

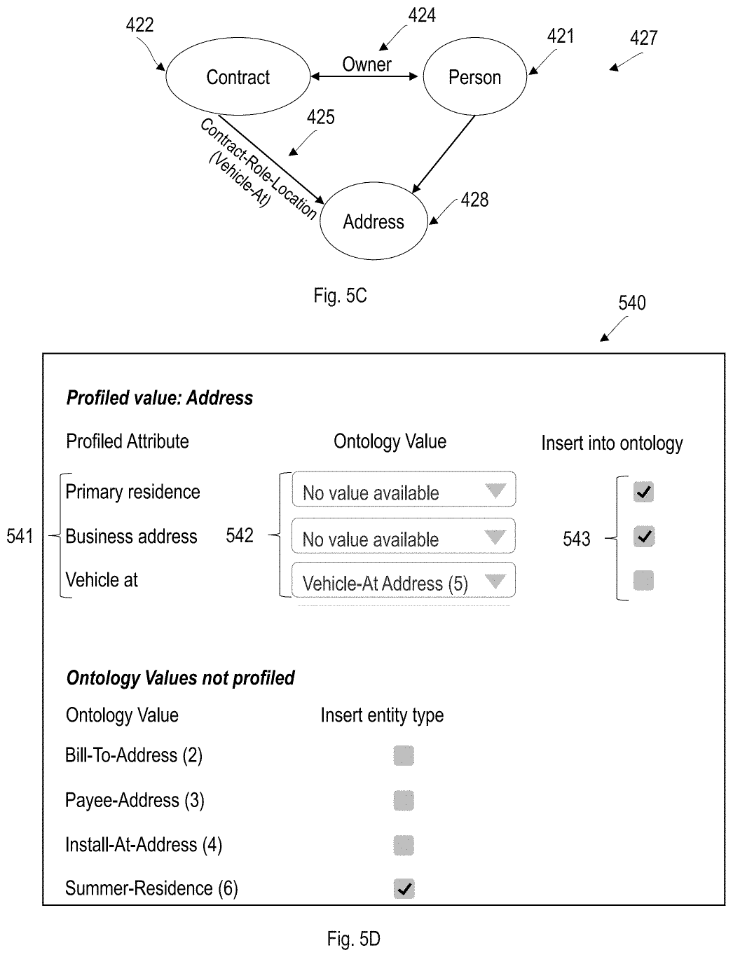

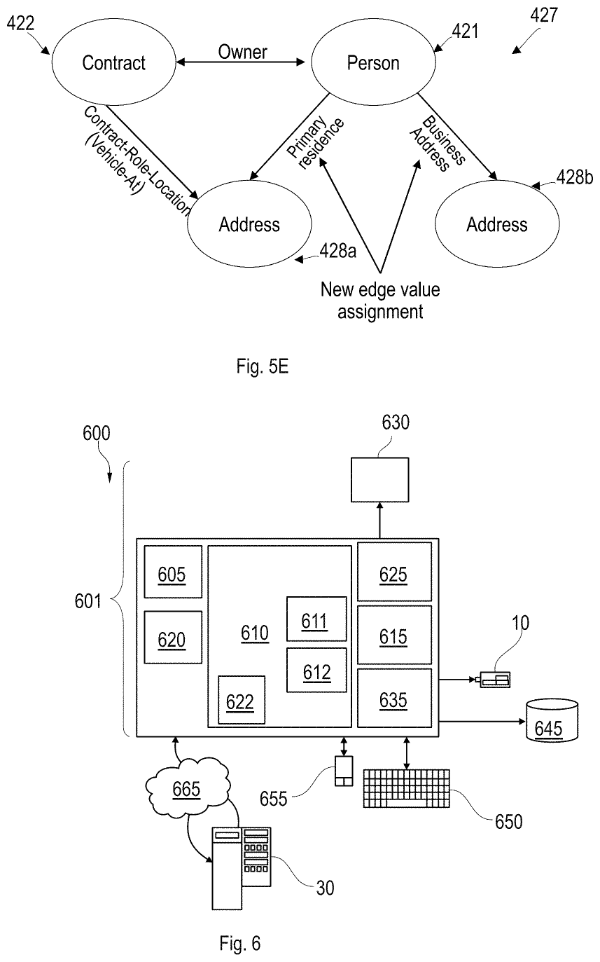

Samples of the values from all attribute types on the graph may be collected in operation 401. A data profile algorithm may be run in operation 403 on the data (and might be integrated with external databases, e.g. common names, common street names tables). The data may be clustered in operation 405 into types of data (considering content and format of data), e.g. bank account numbers that have the format XXX XXX XXX XXX would be in the same cluster, attributes that contain people's names would be in another one and addresses in another one. It may be identified in operation 407 if there are clusters that contain a sufficient variety of attribute types. For example, two attribute types that contain the same type of data indicate that the attributes in the cluster may be transformed into a new entity type. The creation of an entity type or concept Address that has the attribute types of the source cluster as attributes may be suggested in operation 409. This may result in a new ontology as shown in FIG. 4C, where the new concept 428 is added to the ontology of FIG. 4B. Edge restructuring needs may be determined in operation 411 of the new entity type. In addition, new edge insertion needs with edge value assignment through a GUI wizard may be determined in operation 413. This may enable to generate a graph ETL and execute it. FIG. 5A provides further details of steps 411 and 413.

FIG. 5A is a flowchart of a method for determining edge restructuring needs for a new entity type consistent with some embodiments. For the purpose of explanation, the method described in FIG. 5A may be implemented using the system illustrated in FIG. 1A, but is not limited to this implementation. The method of FIG. 5A may, for example, be performed by the data integration system 101.

Following the example of FIG. 4A, where a new concept is added, such as the concept Address, the set of relations associated with the new concept may be determined in operation 501. The set of relations may comprise, for example, existing relations of the ontology 420 and new relations. This is shown in the table 530 of FIG. 5B, where the existing relations 424 and 425 are listed in the first column 531 in addition to the new relation between the person concept and the additional concept Address. Each row of the table 530 may indicate the two concepts (columns 532 and 533) related by the relation of the first column 531 and whether (column 534) a new edge value assignment is required. A new edge value assignment may not be required for the two first relations of the table 530, as they can be maintained and/or reassigned. However, a new edge value assignment may be required for the additional relation involving the new concept and the person concept. Thus, operation 501 may indicate that some existing relations may be reassigned, some existing relations may be maintained and new relations may be required. In particular, it may indicate that the relation 424 may be maintained, the relation 425 may be reassigned and a new relation to be defined. In operation 503, the existing relation 425 may be reassigned as a relation between the contract concept 422 and the new address concept 428. This is show in FIG. 5C, where the relation 524 is maintained and the relation 525 is reassigned. In operation 505, one or more new edge values may be assigned to the new concept 428. For that, a wizard may be used. As shown in FIG. 5D, the wizard 540 may list the concept attributes 541 that have been profiled and associated ontology values 542 if they exist (e.g. as relations) in the ontology 420. The wizard 540 may comprise check boxes 543 to let the user to select the profiled attributes to be inserted in the ontology. Following the example of the ontology 420, the user may check the boxes associated with the two concept attributes primary residence and business address. These may be used for new edge value assignment in the ontology 427. This is shown in FIG. 4E, where the new edge values are inserted in the ontology 427. In one example, these two edge values may be inserted as values of a single edge that links the person concept 421 to the new address concept 428. In another example, the granularity of the new address concept 428 may be changed so that two new concepts are added instead of one. For example, the two new concepts 428a and 428b may be one concept representing the business address and another concept representing the primary residence address. This is illustrated in FIG. 4E, where two new concepts 428a and 428b are added. As shown in FIG. 5D, the wizard may further list ontology values which were not profiled (or not found in the data source) e.g. in order to let the user select to insert a new entity type as indicated in FIG. 5D.

FIG. 6 represents a general computerized system 600 suited for implementing at least part of method steps described in the disclosure.

It will be appreciated that the methods described herein may be at least partly non-interactive, and automated by way of computerized systems, such as servers or embedded systems. In some embodiments, the methods described herein may be implemented in a partly interactive system. These methods may further be implemented in software 612, 622 (including firmware 622), hardware (processor) 605, or a combination thereof. In some embodiments, the methods described herein may be implemented in software, as an executable program, and may be executed by a special or general-purpose digital computer, such as a personal computer, workstation, minicomputer, or mainframe computer. Some general system 600 embodiments, therefore, include a general-purpose computer 601.

In some embodiments, in terms of hardware architecture and as shown in FIG. 6, the computer 601 may include a processor 605, memory (main memory) 610 coupled to a memory controller 615, and one or more input and/or output (I/O) devices (or peripherals) 10, 645 that may be communicatively coupled via a local input/output controller 635. The input/output controller 635 may be, but is not limited to, one or more buses or other wired or wireless connections. The input/output controller 635 may have additional elements, which are omitted for clarity, such as controllers, buffers (caches), drivers, repeaters, and receivers, to enable communications. Further, the local interface may include address, control, and/or data connections to enable appropriate communications among the aforementioned components. As described herein, the I/O devices 10, 645 may include a generalized cryptographic card or smart card.

The processor 605 may be a hardware device for executing software, particularly that stored in memory 610. The processor 605 may be a custom made or commercially available processor, a central processing unit (CPU), an auxiliary processor among several processors associated with the computer 601, a semiconductor-based microprocessor (in the form of a microchip or chip set), or other device for executing software instructions.

The memory 610 may include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). The memory 610 may have a distributed architecture in some embodiments, where various components may be situated remote from one another, but can be accessed by the processor 605.

The software in memory 610 may include one or more separate programs, each of which may comprise an ordered listing of executable program instructions for implementing logical functions, such as functions involved in embodiments of this disclosure. In the example of FIG. 6, software in the memory 610 may include instructions 612 e.g. instructions to manage databases, such as a database management system.

The software in memory 610 may include an operating system (OS) 611. The OS 611 may control the execution of other computer programs, such as software 612, for implementing methods as described herein.

The methods described herein may be in the form of a source program 612, executable program 612 (object code), script, or any other entity comprising a set of instructions 612 to be performed. Embodiment in source form may be translated via a compiler, assembler, interpreter, or the like, which may or may not be included within the memory 610, so as to operate in connection with the OS 611. Furthermore, the methods may be written in an object-oriented programming language, which typically has classes of data and methods, or a procedure programming language, which typically has routines, subroutines, and/or functions.

In some embodiments, a keyboard 650 and mouse 655 may be coupled to the input/output controller 635. Other output devices, such as the I/O devices 645 may include input devices, for example but not limited to: a printer, a scanner, microphone, etc. Additionally, the I/O devices 10, 645 may include devices that communicate both inputs and outputs, for instance but not limited to: a network interface card (NIC) or modulator/demodulator (for accessing other files, devices, systems, or a network), a radio frequency (RF) or other transceiver, a telephonic interface, a bridge, a router, etc. The I/O devices 10, 645 may be also include a generalized cryptographic card or smart card. The system 600 may further include a display controller 625 coupled to a display 630.

In some embodiments, the system 600 may further include a network interface for coupling to a network 665. The network 665 may be an IP-based network for communication between the computer 601 and any external server, client and the like via a broadband connection. The network 665 may transmit and receive data between the computer 601 and external systems 30, which may be involved to perform part or all of the operations discussed herein. In some embodiments, network 665 may be a managed IP network administered by a service provider. The network 665 may be implemented in a wireless fashion, e.g., using wireless protocols and technologies, such as WiFi, WiMax, etc. The network 665 may also be a packet-switched network, such as a local area network, wide area network, metropolitan area network, Internet network, etc. The network 665 may be a fixed wireless network, a wireless local area network W(LAN), a wireless wide area network (WWAN) a personal area network (PAN), a virtual private network (VPN), intranet, etc. and may include equipment for receiving and transmitting signals.

If the computer 601 is a PC, workstation, intelligent device or the like, the software in the memory 610 may further include a basic input output system (BIOS) 622. The BIOS may include a set of software routines that initialize and test hardware at startup, start the OS 611, and support the transfer of data among the hardware devices. The BIOS may be stored in ROM so that the BIOS may be executed when the computer 601 is activated.

When the computer 601 is in operation, the processor 605 may be configured to execute software 612 stored within the memory 610, to communicate data to and from the memory 610, and to generally control operations of the computer 601 pursuant to the software. The methods described herein and the OS 611, in whole or in part, may be read by the processor 605, possibly buffered within the processor 605, and then executed.

In embodiments that are implemented using software 612, as is shown in FIG. 6, the methods may be stored on any computer readable medium, such as storage 620, for use by or in connection with any computer related system or method. The storage 620 may comprise a disk storage, such as hard disk drive storage.

Some embodiments may comprise the following clauses:
Clause 1. A computer implemented method comprising
providing a first graph being an instance of a first ontology, the first ontology comprising concepts and relations, each concept of the concepts being associated with one or more concept attributes;
collecting from the first graph sample values of a plurality of concept attributes of the concept attributes;
clustering the sample values into one or more clusters based on content and/or format of the sample values;
identifying a cluster of the clusters that contains sample values representing different concept attributes, wherein the number of the different concept attributes is higher than a predefined number;
determining at least one additional concept and associated set of relations representing the concept attribute values of the cluster; and
updating the first ontology using the additional concept and associated set of relations, thereby creating a second ontology.
Clause 2. The method of clause 1, determining the set of relations associated with the additional concept comprising:
identifying one or more existing relations of the first ontology, each of the existing relations relating two concepts in accordance with a concept attribute of the identified cluster;
reassigning the identified relations so that they are associated with the additional concept;
defining one or more new relations based on concept attribute values of the cluster;
wherein the set of relations comprises the reassigned relations and the new defined relations.
Clause 3. The method of clause 2, wherein defining the new relations comprises providing an interface for enabling a user to assign the new relations to the additional concept, and receiving via the interface a user input indicative of the new relations.
Clause 4. The method of any of the preceding clauses 1-3, wherein the at least one additional concept comprises one concept per concept attribute of the different concept attributes.
Clause 5. The method of any of the preceding clauses 1-4, wherein the first graph is built using a first dataset, the method further comprising: building a second graph representing the second ontology using a second dataset; or
restructuring the first graph according to the additional concept and the set of relations in order to obtain the second graph; and
using the second graph for accessing data instead of the first graph, wherein the first dataset and second dataset comprise log data of data profiling of same or different ETL systems.
Clause 6. The method of clause 5, wherein restructuring the first graph comprises: creating in the first graph one or more nodes representing instances of the additional concept, wherein the concept attributes values of the cluster become attribute values of the created nodes and/or attribute values associated with edges linked to the created nodes.
Clause 7. The method of clause 5 or 6, further including the operation of automatic matching and identification of duplicates executed at least on the newly created nodes.
Clause 8. The method of any of the preceding clauses 1-7, wherein clustering the sample values comprises: data profiling the collected sample values and performing the clustering based on the results of profiling.
Clause 9. The method of any of the preceding clauses 1-8, wherein the method is applied during loading of data from a plurality of data sources into a database storing the first graph.

The present disclosure may be embodied as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium may be a tangible device that can retain and store instructions for use by an instruction execution device. The computer readable storage medium may be, for example, but is not limited to: an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, however, is not to be construed as being a transitory signal per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, edge servers, etc. A network adapter card or network interface in each computing/processing device may receive computer readable program instructions from the network and may forward the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a computer, or other programmable data processing apparatus to produce a machine, such that the instructions, which execute via the processor of the computer or other programmable data processing apparatus, may implement the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium, having instructions stored therein, may comprise an article of manufacture including instructions that implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions, acts, and/or operations specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one operation, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer implemented method, comprising:
providing a first graph comprising an instance of a first ontology, wherein the first ontology comprises concepts and relations, and wherein one or more of the concepts are associated with one or more concept attributes;
collecting, from the first graph, sample values from a plurality of the concept attributes;
clustering the sample values into one or more clusters based on a content or a format of the sample values;
identifying a first cluster of the one or more clusters that contains one or more of the sample values representing different concept attributes, wherein a number of the different concept attributes is higher than a predefined number;
determining at least one additional concept and associated set of relations representing the concept attributes of the first cluster; and
updating the first ontology using the additional concept and associated set of relations to create a second ontology.

2. The method of claim 1, wherein determining the set of relations associated with the additional concept comprises:
identifying one or more existing relations of the first ontology, wherein each of the existing relations relate a plurality of concepts in accordance with a concept attribute of the identified cluster;
reassigning the identified relations to associate the identified relations with the additional concept;
defining one or more new relations based on concept attribute values of the cluster;
wherein the set of relations comprises the reassigned relations and the defined one or more new relations.

3. The method of claim 2, wherein defining the new relations comprises providing an interface for enabling a user to assign the new relations to the additional concept; and further comprising receiving via the interface a user input indicative of the new relations.

4. The method of claim 1, wherein the at least one additional concept comprises one concept per concept attribute of the different concept attributes.

5. The method of claim 1, wherein the first graph is built using a first dataset, and wherein the method further comprises:
building a second graph representing the second ontology using a second dataset; and
using the second graph for accessing data instead of the first graph, wherein the first dataset and second dataset comprise log data of data profiling of same or different Extract-Transform-Load (ETL) systems.

6. The method of claim 5, wherein restructuring the first graph comprises: creating, in the first graph, one or more nodes representing instances of the additional concept, wherein the concept attributes values of the cluster become attribute values of the created nodes and/or attribute values associated with edges linked to the created nodes.

7. The method of claim 5, further comprising, on the newly created nodes, automatically matching and identifying duplicates.

8. The method of claim 1, wherein clustering the sample values comprises:
data profiling the collected sample values to produce profiling results; and
performing the clustering based on the profiling results.

9. The method of claim 1, wherein the method is applied during loading of data from a plurality of data sources into a database storing the first graph.

10. The method of claim 1, wherein the first graph is built using a first dataset, and wherein the method further comprises:
restructuring the first graph according to the additional concept and the set of relations in order to obtain a second graph; and
using the second graph for accessing data instead of the first graph, wherein the first dataset and the second dataset comprise log data of data profiling of same or different Extract-Transform-Load (ETL) systems.

11. The method of claim 1, wherein each of the one or more concepts is associated with the one or more concept attributes.

12. The method of claim 1, wherein clustering the sample values into the one or more clusters is based on the content and the format of the sample values.

13. The method of claim 1, further comprising outputting the second ontology.

14. A computer program product for augmenting communication, the computer program product comprising a computer readable storage medium having program instructions embodied therewith, the program instructions executable by a processor to cause the processor to:
collect, from the first graph, sample values from a plurality of the concept attributes;
cluster the sample values into one or more clusters based on a content or a format of the sample values;
identify a first cluster of the one or more clusters that contains one or more of the sample values representing different concept attributes, wherein a number of the different concept attributes is higher than a predefined number;
determine at least one additional concept and associated set of relations representing the concept attributes of the first cluster; and
update the first ontology using the additional concept and associated set of relations to create a second ontology.

15. The computer program product of claim 14, wherein determining the set of relations associated with the additional concept comprises:
identifying one or more existing relations of the first ontology, wherein each of the existing relations relate a plurality of concepts in accordance with a concept attribute of the identified cluster;
reassigning the identified relations to associate the identified relations with the additional concept;
defining one or more new relations based on concept attribute values of the cluster;
wherein the set of relations comprises the reassigned relations and the defined one or more new relations.

16. The computer program product of claim 14, wherein the first graph is built using a first dataset, and wherein the method further comprises:
building a second graph representing the second ontology using a second dataset; and
using the second graph for accessing data instead of the first graph, wherein the first dataset and second dataset comprise log data of data profiling of same or different Extract-Transform-Load (ETL) systems.

17. A computer system comprising a processor configured to execute instructions that, when executed on the processor, cause the processor to:
collect, from the first graph, sample values from a plurality of the concept attributes;
cluster the sample values into one or more clusters based on a content or a format of the sample values;
identify a first cluster of the one or more clusters that contains one or more of the sample values representing different concept attributes, wherein a number of the different concept attributes is higher than a predefined number;
determine at least one additional concept and associated set of relations representing the concept attributes of the first cluster; and
update the first ontology using the additional concept and associated set of relations to create a second ontology.

18. The computer system of claim 17, wherein determining the set of relations associated with the additional concept comprises:
identifying one or more existing relations of the first ontology, wherein each of the existing relations relate a plurality of concepts in accordance with a concept attribute of the identified cluster;
reassigning the identified relations to associate the identified relations with the additional concept;
defining one or more new relations based on concept attribute values of the cluster;
wherein the set of relations comprises the reassigned relations and the defined one or more new relations.

19. The computer system of claim 17, wherein the first graph is built using a first dataset, and wherein the method further comprises:
building a second graph representing the second ontology using a second dataset; and
using the second graph for accessing data instead of the first graph, wherein the first dataset and second dataset comprise log data of data profiling of same or different Extract-Transform-Load (ETL) systems.

20. The computer system of claim 17, wherein the first graph is built using a first dataset, and wherein the method further comprises:
restructuring the first graph according to the additional concept and the set of relations in order to obtain a second graph; and
using the second graph for accessing data instead of the first graph, wherein the first dataset and the second dataset comprise log data of data profiling of same or different ETL systems.
